(19) United States
(12) Patent Application Publication
(10) Pub. No.: US 2009/0314764 A1
(43) Pub. Date: Dec. 24, 2009

(54) Electric heating device and manufacturing method thereof

(75) Inventors: Kazuaki Mori, Saitama (JP); Yuusuke Nakamura, Saitama (JP); Kenji Yamaguchi, Saitama (JP)

Correspondence Address: WENDEROTH, LIND & PONACK, L.L.P., 1030 15th Street, N.W.,, Suite 400 East, Washington, DC, 20005-1503, US

(73) Assignee: Calsonic Kansei Corporation

(21) Appl. No.: 12/310,888

(22) PCT Filed: Sep. 10, 2007
(86) PCT No.: PCT/JP2007/067561

§ 371 Date: Mar. 11, 2009

(30) Foreign Application Priority Data
Sep. 13, 2006 (JP) 2006-247573

(51) Int. Cl. H05B 3/06; B23P 17/00

(52) U.S. Cl. 219/520; 29/611

(57) ABSTRACT

An electric heating device includes a heating member (70) having a PTC element (72) and a fin member (80) configured to radiate heat generated in the heater member (70) into the atmosphere. The fin member (80) is provided in contact with a casing member provided outside the heating member (70). The electric heating device includes a pair of sandwiching plates (75, 75) configured to hold a constituent of the heating member that include the PTC element (72) in a vertically sandwiching manner. Moreover, a clip member (90) which is configured to engage end edges of both of the sandwiching plates (75, 75) with each other while applying a load to the sandwiching plates (75, 75) in the sandwiching direction, is provided on front surfaces (75a) of the pair of sandwiching plates (75, 75).

### TECHNICAL FIELD

The present invention relates to an electric heating device including a heating element such as a PTC (positive temperature coefficient) element configured to generate heat by current flow therethrough.

### BACKGROUND ART

An electric heating device has heretofore been known as disclosed in, for example, EP Patent No. 0575649, which includes: heating units each provided with a fin in contact with an elongated heating member provided with a PTC element configured to generate heat by current flow therethrough; a heater stacked body formed by stacking these heating units in a direction of the arrangement of the heating members and the fins; and a pair of housing members to support two ends of this heater stacked body in the longitudinal direction.

An electric heating device of this type employs a structure in which the PTC elements provided with an electrode plate and an insulating plate being sequentially superposed thereon are accommodated in a conductive tube; the tube is pressed in a direction of superposition of the PTC elements and the plates so that the electrode plate and the tube are pressure-bonded to the PTC elements; and moreover, the fin located on an outer side surface of the tube is pressure-bonded or adhered.

Then, current is caused to flow in the PTC elements through the tube and the electrode plate by connecting the fin and the electrode plate to the positive side and the negative side of a power source, respectively.

### DISCLOSURE OF THE INVENTION

### Problems to be Solved by the Invention

However, in the above-described conventional technique, the contact between the fin and the tube is established either by pressure bonding or by adhesive bonding. Accordingly, there is a risk of inadequate adhesion between the fin and the tube. If the adhesion between the fin and tube is inadequate as mentioned above, thermal resistance grows larger than the case where the adhesion is sufficient, and thus only a lesser radiation property is obtained.

Further, the contact achieved by pressing the tube has a risk of time deterioration in contact pressure between the PTC elements, the tube and the electrode and it is therefore difficult to manage the contact pressure. Moreover, reduction in the contact pressure incurs deterioration in electric conductivity and an increase in the thermal resistance, thereby deteriorating thermal efficiency.

In addition, since the heating portions such as the PTC elements, the electrodes, and the like are put into the tube and then pressed, it is necessary to prepare a dedicated press machine that involves equipment costs. Moreover, if a defect occurs in the heating portion, it is difficult to take out and repair the component. Thus, the conventional technique has poor maintainability.

The present invention has been made in view of the above-described problems of the conventional technique. An object of the present invention is to provide an electric heating device that is excellent in thermal efficiency, manufacturable at low costs, and excellent in maintainability, and to provide a manufacturing method thereof.

### Means for Solving the Problems

To attain the object, an electric heating device according to an example of the present invention includes: a heating unit having a heating element which is formed in an elongated shape and is configured to generate heat by current flow therethrough, a casing member provided outside the heating unit, and a fin member provided in contact with the casing member, and configured to radiate the heat generated in the heating unit into the atmosphere, wherein the casing member includes a pair of sandwiching plates configured to hold a constituent of the heating unit having the heating element from both sides of the constituent in a sandwiching manner, the fin member is brazed onto a front surface of each of the pair of sandwiching plates, a rear surface of each of the pair of sandwiching plates being a surface by which the constituent is held, and an engaging mechanism is provided to engage end edges of the respective sandwiching plates with each other while applying a load onto the sandwiching plates in a direction sandwiching the constituent.

### EFFECTS OF THE INVENTION

According to the electric heating device of the present invention, the fin members are preliminarily brazed to the sandwiching plates to join the fin members and the sandwiching plates, and the constituent of the heating unit such as the heating elements is sandwiched with the two sandwiching plates. Thereafter, the end edges of the sandwiching plates are engaged with each other by using the engaging mechanism.

Since the fin members are joined to the sandwiching plates by brazing, it is possible to enhance heat transmission efficiency and thereby to improve thermal efficiency as compared to the case of pressure-bonding or adhesive-bonding the fin member to the casing.

Moreover, unlike the case where the constituent of the heating unit is accommodated into the tube and then pressed, it is not necessary to provide a dedicated press machine. Accordingly, it is possible to reduce equipment costs.

Furthermore, the contact pressure to the heating element sandwiched between the sandwiching plates is obtained by the load applied from the engaging mechanism. Accordingly, it is easier to set the contact pressure and to prevent the overtime reduction of the contact pressure as compared to the case of setting the contact pressure by pressing. In this way, it is possible to maintain electric conductivity and thermal resistance favorably and thereby to improve thermal efficiency.

In addition, releasing the engagement obtained by the engaging mechanism allows the constituent of the heating unit sandwiched by the sandwiching plates to be taken out. Accordingly, as compared to the case where the constituent of the heating unit is accommodated into the tube and then pressed, it is easier to conduct repair when a defect occurs. Therefore, the present invention has excellent maintainability.

### BRIEF DESCRIPTION OF THE DRAWINGS

FIG. 1 is an exploded perspective view showing a heating unit 40 in an electric heating device A according to a first example of the best modes for carrying out the invention.

FIG. 2 is a perspective view showing the electric heating device A according to the first example of the embodiment of the present invention.

FIG. 3 is a perspective view showing the heating unit 40 in the electric heating device A according to the first example of the embodiment of the present invention.

FIG. 4 is a side view showing the heating unit 40 in the electric heating device A according to the first example of the embodiment of the present invention.

FIG. 5 is a perspective view showing an end of a sandwiching plate 75 applied to the electric heating device A according to the first example of the embodiment of the present invention.

FIG. 6 is a perspective view showing the heating unit 40 in the electric heating device A according to the first example of the embodiment of the present invention, which shows a state immediately before engaging clip members 90.

FIG. 7 is a configuration explanatory view showing an outline of a configuration of a vehicle air conditioning unit ACU applying the electric heating device A according to the first example of the best modes for carrying out the invention.

FIG. 8 is a side view showing a heating unit 240 in an electric heating device according to a second example of the embodiment of the present invention.

FIG. 9 is a perspective view showing an electric heating device C according to a third example of the embodiment of the present invention.

FIG. 10 is an exploded perspective view showing a heating unit 340 applied to the electric heating device C according to the third example of the embodiment of the present invention.

FIG. 11 is a perspective view showing an end of a sandwiching plate 375 in the heating unit 340 applied to the electric heating device C according to the third example of the embodiment of the present invention.

FIG. 12 is a perspective view showing the sandwiching plate 375 joining a fin member 80, which is applied to the heating unit 340 applied to the electric heating device C according to the third example of the embodiment of the present invention.

FIG. 13 is a perspective view for explaining procedures to assemble the heating unit 340 applied to the electric heating device C according to the third example of the embodiment of the present invention.

FIG. 14 is a perspective view showing substantial part in the course of an assembly operation of the heating unit 340 applied to the electric heating device C according to the third example of the embodiment of the present invention.

FIG. 15 is a side view showing a heating unit applied to another example of an electric heating device according to the embodiment of the present invention.

FIG. 16 is a side view showing a heating unit applied to another example of an electric heating device according to the embodiment of the present invention.

### EXPLANATION OF REFERENCE NUMERALS

70 HEATING MEMBER (HEATING UNIT)
71 POSITIONING PLATE (CONSTITUENT)
72 PTC ELEMENT (HEATING ELEMENT)
73 ELECTRODE PLATE (CONSTITUENT)
74 INSULATING PLATE (CONSTITUENT)
75 SANDWICHING PLATE
75a FRONT SURFACE
75b LOCKING CLAW PORTION (CONCAVO-CONVEX SHAPED PORTION)
75c REAR SURFACE
80 FIN MEMBER
90 CLIP MEMBER (ENGAGING MECHANISM)
280 FIN MEMBER
280a NOTCH
375 SANDWICHING PLATE
375a FRONT SURFACE
375b REAR SURFACE
375d ENGAGING CLAW (ENGAGING MECHANISM)
375f PROTRUSION

### BEST MODES FOR CARRYING OUT THE INVENTION

Now, an embodiment of the present invention will be described below in detail based on some examples illustrated in the accompanying drawings for materializing this embodiment.

### First Example

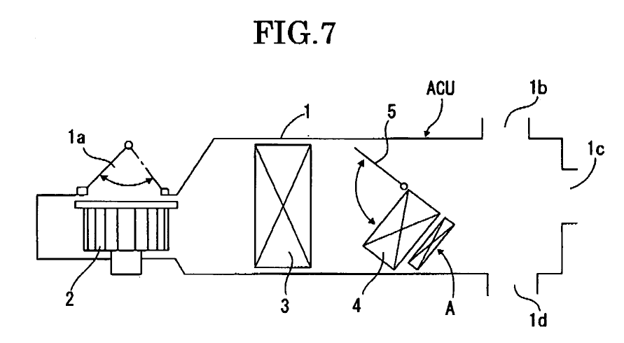

An electric heating device A of the first example is applied to a vehicle air conditioning unit ACU shown in FIG. 7.

This vehicle air conditioning unit ACU includes a blower fan 2, an evaporator 3, and a heating core 4 which are sequentially arranged from a side of an air inlet 1a of a unit housing 1. Moreover, an air mix door 5 is provided in the vicinity of the heating core 4. The vehicle air conditioning unit ACU is structured in a way that adjusting the aperture of the air mix door 5 allows a mixing ratio between cool air passing through the evaporator 3 and warm air passing through the heating core 4 to be adjusted as needed, thereby enabling to adjust air temperature emitted from each of outlets 1b, 1c, and 1d.

The electric heating device A of the first example is configured to generate heat by current flow therethrough, and is arranged parallel to the heating core 4 and configured to cause current to flow therethrough to generate heat when a heating temperature of the heating core 4 is inadequate. For example, the electric heating device A is used for a vehicle such as a diesel vehicle in which an unillustrated propulsion system employs relatively low-temperature cooling water.

Details of the electric heating device A of the first example will be described below.

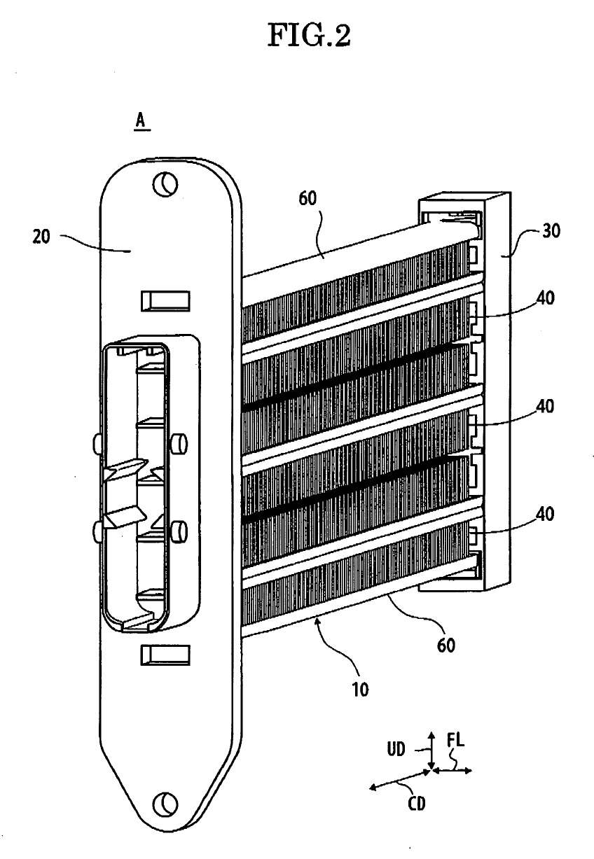

As shown in FIG. 2, the electric heating device A is formed by attaching a front housing 20 and an end housing 30 to both ends of a heater stacked body 10 in a longitudinal direction (in a direction of an arrow CD).

The heater stacked body 10 is formed by stacking three heating units 40, 40, and 40 vertically (the stacking direction of the heating units 40, which is the direction of an arrow UD in this drawing, will be referred to as a vertical direction), and sandwiching upper and lower ends of this stacked body with end plates 60 and 60.

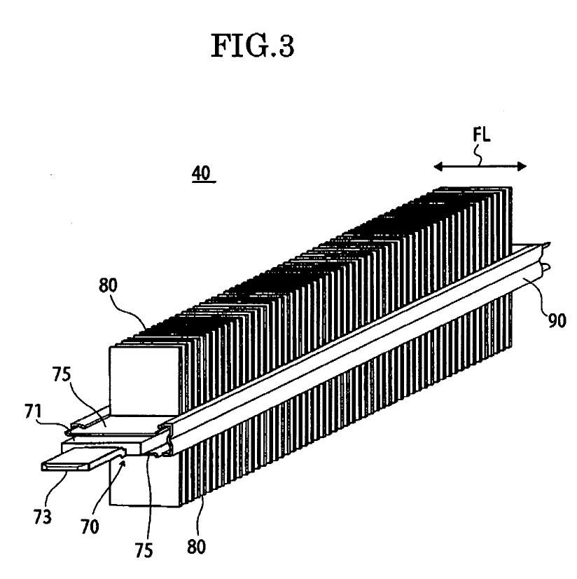

FIG. 3 is a perspective view showing the heating unit 40. The heating unit 40 is formed by joining fin members 80 and 80 to upper and lower ends of a heating member (a heating unit) 70, respectively.

Here, the fin member is formed of a metal plate material (for example, an aluminum or an aluminum alloy plate material) having excellent thermal conductivity, and formed into a corrugated shape. Such fin member transmits the heat transferred from the heating member 70 to air that flows in a width direction which is a direction of an arrow FL.

Although detailed illustration is omitted, the front housing 20 and the end housing 30 are formed in supportable shapes that allow insertion of both ends of each heater stacked body 10, and also have structures to cause current to flow into the heating member 70. Meanwhile, the front housing 20 is formed so as to allow connection of a power supply connector (not shown).

Here, the front housing 20 and the end housing 30 are formed of a material having excellent electrical-insulation and heat-resistance properties such as fiber reinforced PBT (polybutylene terephthalate). This fiber reinforced PBT has low water absorption and thermal expansion coefficient and therefore exhibits excellent dimensional stability, and also has features characterized in that the fiber reinforced PBT has an excellent electrical-insulation property, allows only a small change in the electrical characteristic caused by moisture absorption, and has a high tolerance with respect to insulation breakdown voltage.

Next, the above-mentioned heating member 70 will be described in detail.

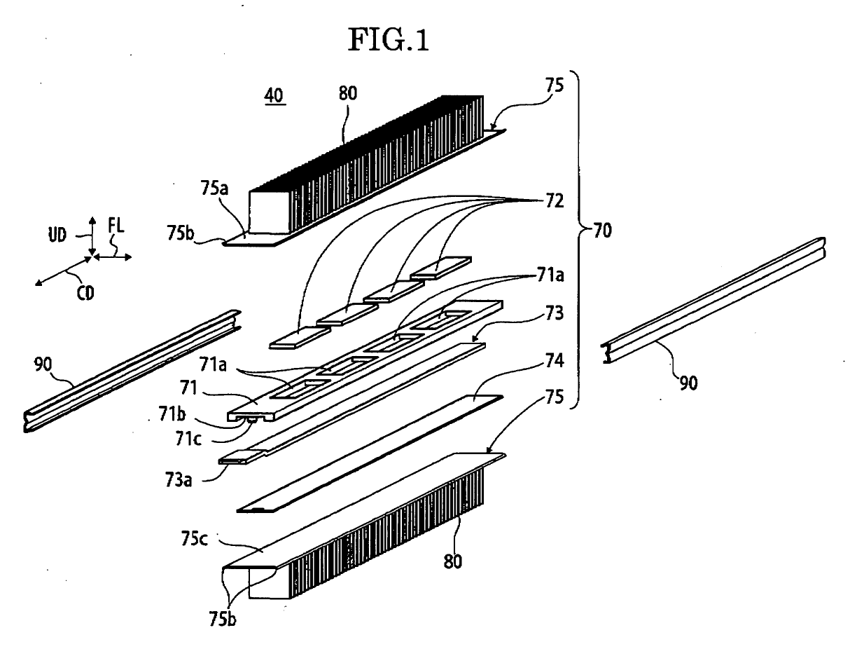

As shown in FIG. 1, the heating member 70 includes a positioning plate 71, multiple (four pieces in this first example) PTC elements (heating elements) 72, an electrode plate 73, an insulating plate 74, and sandwiching plates 75.

The positioning plate 71 is configured to arrange the multiple PTC elements 72 in the longitudinal direction (the direction of the arrow CD) at given intervals. The positioning plate 71 is formed in a plate shape and made of a material having excellent-insulating and thermal-resistance properties (for example, polyamide).

Moreover, holding holes 71a, 71a, 71a, and 71a for holding the PTC elements 72 are formed in four locations of the positioning plate 71, and a concave groove 71b into which the later-described electrode plate 73 is inserted is formed on a lower side surface, in the drawing, of the positioning plate 71.

Meanwhile, an engaging claw 71c to be engaged with the electrode plate 73 so as to determine the relative position of both of the constituents in predetermined positions is formed on one end of the positioning plate 71.

The PTC element 72 is typically a semiconductor ceramic containing barium titanate (BaTiO₃) as a main component, and has a property to generate heat by current flow therethrough. Incidentally, in the first example, each PTC element 72 is formed substantially into a rectangular plate shape and located in the corresponding holding hole 71a in the positioning plate 71.

The electrode plate 73 is a plate having a rectangular plate shape as illustrated in the drawing, and has conducting properties. Moreover, a connection terminal 73a to be connected to an unillustrated connector is formed in a bent manner on an end edge of the electrode plate 73.

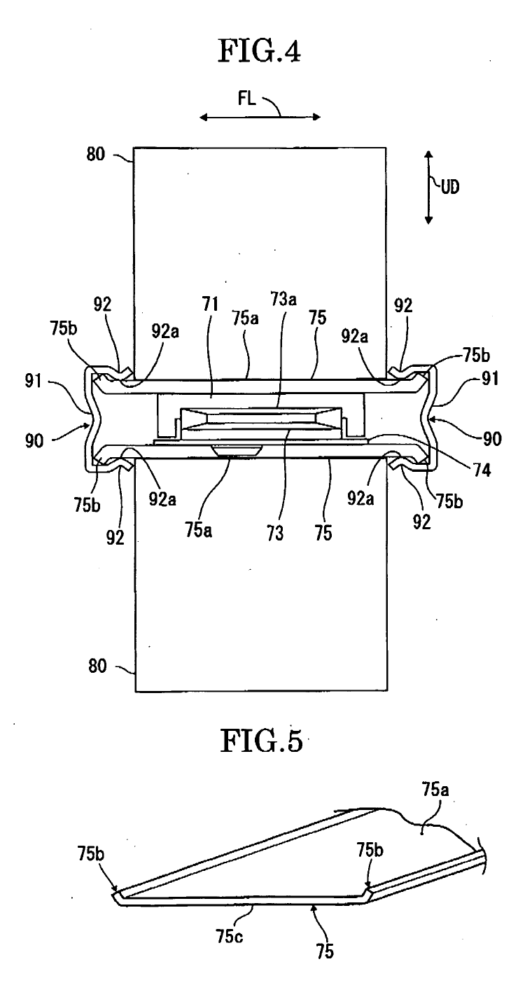

The insulating plate 74 is formed in a rectangular thin plate shape and made of insulative resin or the like. Moreover, this insulating plate 74 is formed wider than the electrode plate 73 (see FIG. 4).

Each sandwiching plate 75 is formed in a substantially rectangular plate shape, made of metal having conducting properties, and is formed wider than the positioning plate 71, the electrode plate 73, the insulating plate 74, and fin members 80 (see FIG. 4).

Moreover, each fin member 80 is joined to a front surface 75a of the corresponding sandwiching plate 75 by brazing. Further, as shown in FIG. 5, locking claw portions 75b and 75b which are concavo-convex shaped portions curved toward the front surface 75a, are formed on both ends in the width direction of the sandwiching plate 75.

As also shown in FIG. 4, the heating member 70 is formed by sequentially stacking the electrode plate 73 and the insulating plate 74 on the lower side, in the drawing, of the positioning plate 71 that holds the PTC elements 72, all of which are supported by being sandwiched vertically by the sandwiching plates 75.

Moreover, the sandwiched state of the members 71, 72, 73, and 74 of the heating member 70 realized by the sandwiching plates 75 and 75 is retained by engaging the end edges of the pair of sandwiching plates 75 and 75 by using clip members 90 and 90 serving as an engaging mechanism.

Specifically, the clip members 90 each have a length substantially equal to the entire length of the heating member 70 as shown in FIG. 1. Moreover, as shown in FIG. 4, a pair of engaging pieces 92 and 92 engaged with the locking claw portions 75b of the sandwiching plates 75 and 75 is formed above and below bodies 91, respectively. Moreover, on each engaging piece 92, an engaging convex portion 92a which is curved so as to protrude toward the opposed engaging piece 92 is formed.

Moreover, the body 91 is formed in such bent shape that its central portion protrudes in the protruding direction of the engaging pieces 92. In this way, a restoring force is generated which reduces a distance between the engaging pieces 92 by elastic deformation in the direction to increase bending when the engaging pieces 92 and 92 are displaced in the vertical direction which is the relatively separating direction.

Next, assembly procedures of the electric heating device A of the first example will be described.

In this assembly, each heating unit 40 is assembled first.

When assembling the heating unit 40, the fin member 80 is preliminarily brazed onto the front surface 75a of each sandwiching plate 75.

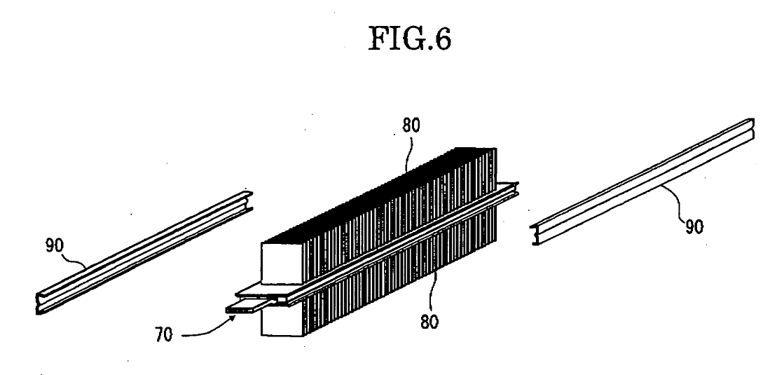

Then, the PTC elements 72, 72, 72, and 72 are inserted into the respective holding holes 71a, 71a, 71a, and 71a in the positioning plate 71. Moreover, the electrode plate 73 and the insulating plate 74 are sequentially stacked on the lower side of this positioning plate 71, and rear surfaces 75c and 75c of the sandwiching plates 75 and 75 joined to the fin members 80 are stacked thereon. What is assembled up to this point is the heating member 70 with the fin members 80 and 80 joined thereto, as shown in FIG. 6.

The engaging pieces 92 and 92 of the clip members 90 and 90 are engaged vertically with both of the end edges in the width direction of the vertical pair of the sandwiching plates 75 and 75 in this state. As a result, the heating unit 40 shown in FIG. 3 is assembled.

Here, to engage the clip members 90 as described above, both of the engaging pieces 92 and 92 of the clip members 90 and 90 are elastically deformed so as to open vertically, and then the end edges of both of the sandwiching plates 75 and 75 are inserted into and engaged between both of the engaging pieces 92 and 92 as shown in FIG. 4.

At this time, the engaging pieces 92 and 92 and the body 91 of the clip member 90 are elastically deformed and the restoring force applies in the direction to reduce the distance between the engaging pieces 92 and 92. By this restoring force, a load in the sandwiching direction is applied from the sandwiching plates 75 and 75 to the positioning plate 71, the PTC elements 72, the electrode plate 73, and the insulating plate 74 sandwiched between the sandwiching plates 75 and 75.

Therefore, contact pressure on the PTC elements 72 from the electrode plate 73 and the insulating plate 74 is obtained by use of the load created by this restoring force. This contact pressure is ensured as long as the elastically deformed state of the clip member 90 is retained.

Meanwhile, in this engaged state, the engaging convex portions 92a of the respective engaging pieces 92 are engaged with the locking claw portions 75b of the sandwiching plates 75 along the width direction, thereby avoiding detachment of the clip member 90, i.e., avoiding the clip members 90 from separated from the sandwiching plates 75 and 75.

When each of the heating units 40 is assembled as described above, three sets of these heating units 40 are stacked on one another and maintained at this integrated state by sandwiching upper and lower ends thereof with the end plates 60. Then, one end of each of the heating units 40, 40, and 40 and each of the end plates 60 and 60 is inserted into the end housing 30 while the other end of the same is inserted into the front housing 20. As a result, the electric heating device A of the first example shown in FIG. 2 is assembled. Here, the front housing and the end housing 30 are provided with engaging claws (not shown) that are engageable and disengageable with and from the respective heating units 40, 40, and 40 and the end plates 60 and 60, so that electric heating device A can be disassembled at the time of maintenance.

In this first example, current is caused to flow into the PTC elements 72 by use of the electrode plate 73 and the sandwiching plates 75 and 75. Here, the connection terminal 73a of the electrode plate 73 and the sandwiching plates 75 are configured to cause current to flow when the unillustrated connector is connected to the front housing 20. Note that the insulating plate 74 prevents a short circuit between the electrode plate 73 and the sandwiching plate 75.

As described above, in the electric heating device A of the first example, the fin member 80 is joined by brazing to the sandwiching plate 75 to which the heat is transferred from the PTC elements 72. Accordingly, it is possible to enhance heat transmission efficiency and thereby to improve thermal efficiency as compared to the case of pressure-bonding or adhesive-bonding the fin members 80 to the sandwiching plates 75.

Moreover, in the heating member 70, the constituents 71, 72, 73, and 74 including the PTC elements 72 are supported by sandwiching them with the two sandwiching plates 75 and 75, and the end edges of these sandwiching plates 75 and 75 are engaged with one another by use of the clip members 90, so that the sandwiched state of the constituents are retained.

Therefore, unlike the case where the constituents of the heating member 70 are put into a tube and then pressed, this first example does not require a dedicated press machine and is therefore capable of reducing equipment costs. Moreover, it is possible to sandwich the positioning plate 71, the PTC elements 72, the electrode plate 73, and the insulating plate 74, which are the constituents of the heating member 70, by using the sandwiching plates 75 to which the fin members 80 are preliminarily brazed.

Specifically, in the conventional structure in which a tube is used for pressing, it is not possible to execute pressing if the fin members 80 are preliminarily brazed. If it is brazed after the pressing, then the heat at the time of brazing deteriorates the performances of the PTC elements 72. On the contrary, in this first example, it is possible to support the constituents 71, 72, 73, and 74 including the PTC elements 72 of the heating member 70, even after performing brazing beforehand.

Moreover, in the first example, the engaging convex portion 92a is formed in order to engage the clip member 90 with the sandwiching plates 75 and 75. It is possible to set the load to be inputted from the clip member 90 to the sandwiching plates 75 by adjusting a protruding margin of this engaging convex portion 92a. Therefore, it is easy to carry out initial setting of the sandwiching load.

Meanwhile, in the first example, the contact pressure between the electrode plate 73 and the sandwiching plates 75, which touch the PTC elements 72 to cause current to flow therethrough and thermal transmission, as well as the PTC elements 72 is obtained by the load given by the restoring force created by the elastic deformation of the clip member 90. Therefore, it is easy to set the contact pressure in comparison with setting the contact pressure by pressing. In addition, it is possible to prevent decrease in the contact pressure over time. In this way, it is possible to maintain electric conductivity and thermal resistance favorably and thereby to improve thermal efficiency.

In addition, releasing the engagement by the clip members 90 allows the constituents 71, 72, 73, and 74 of the heating member 70 to be taken out which are sandwiched by the sandwiching plates 75 and 75. Accordingly, as compared to the case where these constituents 71, 72, 73, and 74 are put into a tube and then pressed, it is easier to conduct repair when a defect occurs.

Meanwhile, in the first example, the pair of clip members 90 and 90 are fixed to the respective end edges of the two sandwiching plates 75 and 75 so as to establish the engaged state of the end edges.

As described above, this first example has excellent workability because it requires the smaller number of the clip members 90 to be fixed and therefore reduces the number of operations. In addition, by forming the body 91 of the clip member 90 into a chevron-like cross-section by bending a central part thereof, the central part in the vertical direction of the body 91 is elastically deformed when widening the engaging pieces 92 and 92. Hence it is possible to secure a larger deformation margin as compared to the case of deforming base end portions of the engaging pieces 92 and 92 as in the case of forming the body 91 into a straight shape. Therefore, it is easy to set the load to be applied to the sandwiching plates 75 and 75, and is possible to obtain the load stably.

Moreover, the locking claw portions 75b and 75b are formed on the end edges of each sandwiching plate 75 and the engaging convex portions 92a are formed on the engaging pieces 92 of each clip member 90. Accordingly, when the clip members 90 are engaged with the sandwiching plates 75 and 75, the locking claw portions 75b are engaged with the engaging convex portions 92a along the width direction so as to prevent detachment of the clip members 90.

Since the clip members 90 are prevented from detachment as described above, it is possible to maintain the above-described engaged state more reliably and thereby to obtain the above-mentioned effect of improving thermal efficiency reliably.

Meanwhile, in the first example, one of the sandwiching plates 75 and 75 is used as the electrode. Accordingly, it is possible to reduce the number of electrode plates 73 and the insulating plates 74 required, compared to a case where two electrode plates 73 are used for causing current to flow into the PTC elements 72.

In this way, the number of components can be reduced, which in turn reduces the weight and manufacturing costs.

### Second Example

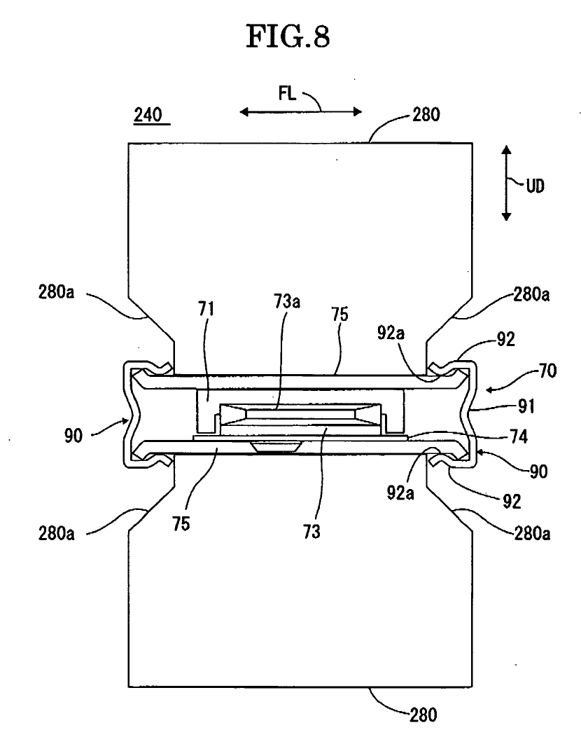

Next, an electric heating device according to a second example of the embodiment of this invention will be described based on FIG. 8. Since this second example is a modified example of the first example, only the differences will be described while omitting explanations of the configurations, operation, and effects similar to those in the first example.

This second example represents an example in which notches 280a and 280a are formed on base end portions of a fin member 280.

Specifically, as shown in FIG. 8 that represents a side view of a heating unit 240, the notches 280a and 280a for avoiding interference by the clip members 90 are formed on both ends, in the width direction (a direction of an arrow FL), of the base end portion of each fin member 280 brazed to the sandwiching plate 75, the notches 280a and 280a being formed in positions so as to appear to overlap the clip members 90 when seen in the vertical direction.

Therefore, in the second example, it is possible to provide a larger dimension of the fin member 290 in the width direction excluding the base end portion thereof, then the case of not providing the notches 280a.

In this way, it is possible to improve a heat radiation performance without increasing the size of the entire device and to improve thermal efficiency as well.

Note that the configurations other than the fin members 280 in the second example are similar to those in the first example and descriptions thereof will be thus omitted.

### Third Example

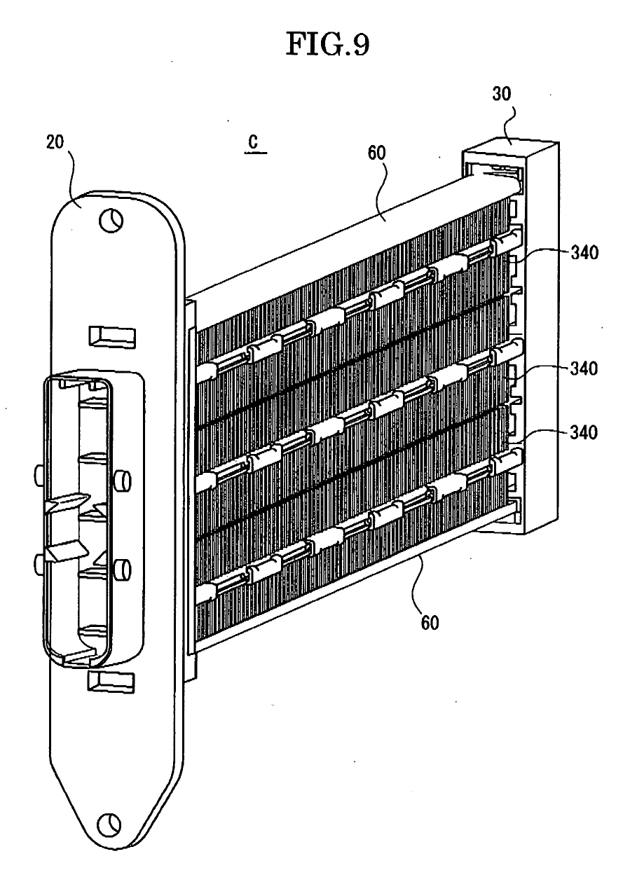

Next, an electric heating device C according to a third example of the embodiment of this invention will be described based on FIG. 9 to FIG. 14. Since this third example is a modified example of the first example, only the differences will be described while omitting explanations of the configurations, operation, and effects that are similar to those in the first example.

As shown in FIG. 9, the electric heating device C of the third example is formed by vertically stacking three heating units 340 as similar to the first example.

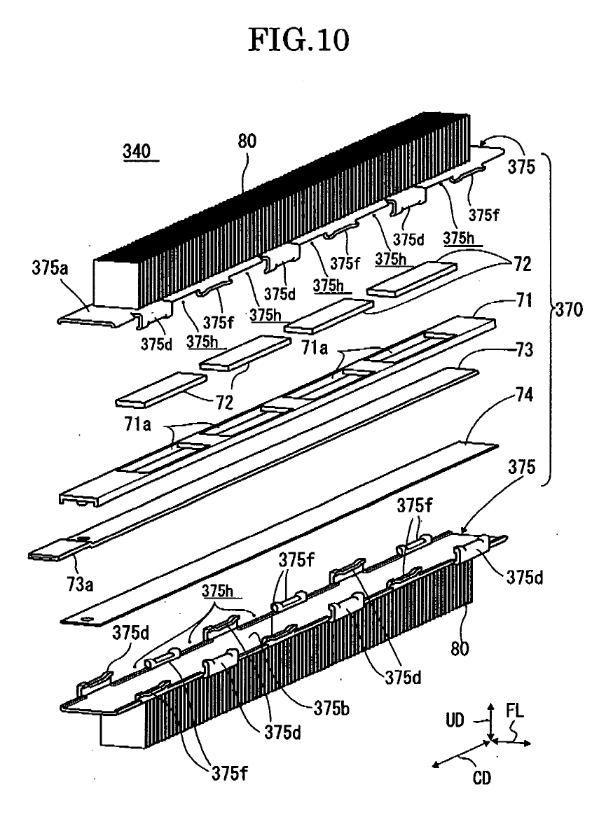

As shown in FIG. 10, in a heating unit 340 of this third example, the configuration of the engaging mechanism for engaging end edges of sandwiching plates 375 with each other is different from the first example. Now, this difference will be described below.

In the third example, engaging claws 375d serving as the engaging mechanism are integrally formed on the sandwiching plates 375.

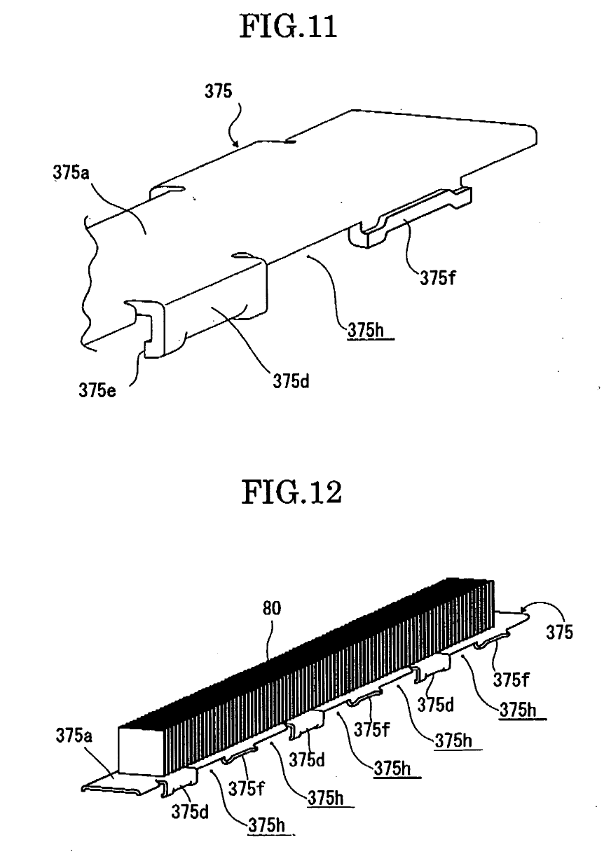

Specifically, the engaging claw 375d is formed by bending a portion continuous to the end edge of the sandwiching plate 375 almost perpendicularly to a rear surface 375b and then bending a tip end thereof almost perpendicularly so as to face the rear surface 375b. A claw portion 375e is formed on a tip of the bent portion (see FIG. 11).

Here, as illustrated in the drawing, these engaging claws 375d are formed in three locations at the end edges of each sandwiching plate 375 at constant intervals in the longitudinal direction. Moreover, the engaging claws 375d are arranged alternately in the width direction at the both end edges of each sandwiching plate 375 so that the engaging claws 375d do not overlap one another in the width direction.

Furthermore, on the end edges of each sandwiching plate 375, protrusions 375f are formed alternately with the engaging claws 375d. In addition, a distance 375h having substantially the same dimension as the dimension of the engaging claw 375d in the longitudinal direction is provided between the engaging claws 375d and the protrusions 375f.

Each protrusion 375f is located in a position so as to face the corresponding engaging claw 375d when the rear surfaces 375b of the sandwiching plates 375 are faced to each other, and is formed engageably with the corresponding engaging claw 375d.

Moreover, this protrusion 375f is formed so as to protrude toward the front surface of its sandwiching plate 375 as shown in FIG. 14 for the purpose of locating the position of engagement with the corresponding engaging claw 375d away from the sandwiching plate 375 on the side in which the engaging claw 275d is provided when being engaged with this engaging claw 375d. Moreover, inclined surfaces 375g are formed on the both end edges of each sandwiching plate 375 in the longitudinal direction (a direction of an arrow CD).

Next, assembly procedures of the heating unit 340 will be described.

In this third example as well, similarly to the first example, each fin member 80 is preliminarily joined by brazing to a front surface 375a of the corresponding sandwiching plate 375 as shown in FIG. 12.

Next, similarly to the first example, the PTC elements 72 are held in the respective holding holes 71a on the positioning plate 71 as shown in FIG. 10. Moreover, the electrode plate 73 and the insulating plate 74 are stacked on the lower side of this positioning plate 71, and these stacked constituents are stacked on one of the sandwiching plates 375.

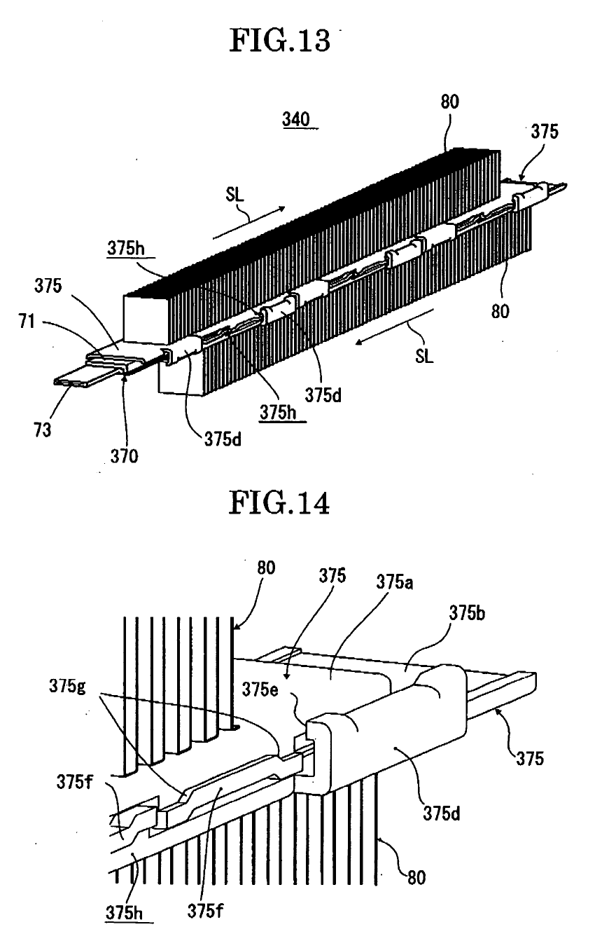

Thereafter, the sandwiching plates 375 and 375 are engaged with each other. Here, in this third example, the engaging claws 375d and the protrusions 375f in one of the sandwiching plates 375 are first placed in the portions of the distance 375h in the other sandwiching plate 375, as shown in FIG. 13.

Next, from this state, the protrusions 375f are inserted respectively into the backsides of the claw portions 375e of the engaging claws 375d by relatively sliding the sandwiching plates 375 in the direction of an arrow SL in FIG. 13. In this way, the claw portions 375e of the engaging claws 375d move vertically toward the front surface 375a of the sandwiching plate 375 which is the opponent of engagement, whereby the distance between the rear surfaces 375b of the both sandwiching plates 375 is reduced.

Consequently, the sandwiching plates 375 and 375 including the engaging claws 375d are elastically deformed and the restoring forces thereof act in the sandwiching direction.

Note that, at the time of the relative sliding of these sandwiching plates 375 and 375, the claw portions 375e of the engaging claws 375d move gradually in the vertical direction along the inclined surfaces 375g of the protrusions 375f. Accordingly, the change in the distance between the rear surfaces 375b of the both sandwiching plates 375 mentioned above, i.e., the aforementioned elastic deformation is also performed gently.

As described above, according to the electric heating device C of the third example, when engaging the end edges of the both sandwiching plates 375 and 375 with each other, the engaging claw 375d formed on one of the sandwiching plates 375 is engaged with the protrusion 375f formed on the other sandwiching plate 375. Therefore, it is not necessary to provide an engaging mechanism separately from the sandwiching plates 375. Hence, it is possible to decrease the number of components and thereby to reduce manufacturing costs.

Moreover, by providing the protrusion 375f, the position of engagement of the engaging claw 375d is located away from the front surface of the sandwiching plate 375 which is the opponent of engagement. In this way, the distance between the sandwiching plates 375 and 375 is shortened, which in turn acts as a load in the sandwiching direction of the both sandwiching plates 375 and 375. For this reason, it is possible to obtain a sandwiching load reliably and to set the sandwiching load by means of the protruding margins of the protrusions 375 Hence it is easy to carry out the initial setting of the sandwiching load.

In addition, since the engaging claws 375d and the protrusions 375f are alternately arranged on the end edges of each sandwiching plate 375, the directions of tension of the end edges are alternately changed, hence achieving equalization of the sandwiching load. In this way, it is possible to equalize the contact pressure entirely onto the PTC elements 72 sandwiched between the sandwiching plates 375 and 375, and to improve electric conductivity as well as thermal transmission. As a result, the thermal efficiency is improved.

Moreover, in this third example, the distance 375h having substantially the same dimension as the longitudinal dimension of the engaging claw 375d is formed between the engaging claw 375d and the protrusion 375f. At the time of assembly, the engaging claw 375d is located at this distance 375h and then the engaged state is achieved by relatively sliding the sandwiching plates 375.

In this way, an operation to elastically deform the engaging claws 375d or the like is not required at the time of engagement. Accordingly, it is possible to carry out an assembly operation smoothly.

Here, other advantageous effects in the third example are similar to those in the first example.

Specifically, the point in that it is possible to improve thermal efficiency by joining the fin member 80 to the sandwiching plate 375 by brazing, the point in that it is not necessary to provide a dedicated press machine and it is therefore possible to reduce equipment costs in comparison with pressing, the point in that it is easy to set the contact pressure to the PTC elements 72 and to improve thermal efficiency by allowing prevention of reduction in the contact pressure with time, the point in that it is possible to disassemble the sandwiching plates 375 and 375 by releasing the engagement when a defect occurs and is therefore excellent in maintainability, and the point in that it is possible to reduce the numbers of the electrode plates 73 and the insulating plates 74 required therein by using the sandwiching plate 375 as the electrode apply similarly to the first example.

The embodiment and the first example to the third example of the present invention have been described above in detail with reference to the drawings. It is to be noted that the concrete configurations are not limited only to the embodiment and the first example to the third example, and that the present invention encompasses design changes to the degree not departing from the scope of the present invention.

For example, the first example to the third example show the case of forming the heater stacked body 10 by stacking three sets of the heating units 40. However, the present invention is not limited only to this configuration. It is also possible to apply a structure other than stacking three sets, such as a configuration to stack multiple sets other than three sets such as two sets or four sets, or a configuration to use only one heating unit 40.

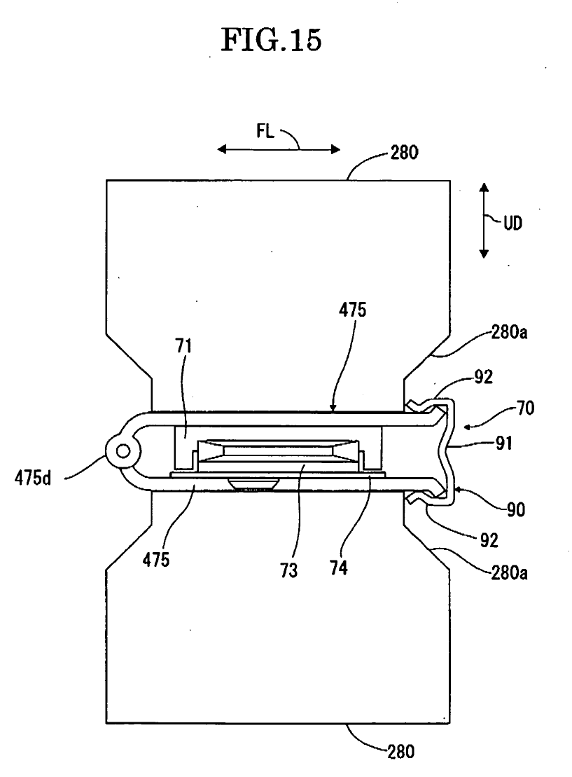

Meanwhile, the first example to the third example show the case of using two vertically arranged sandwiching plates 375 and 375. Instead, as shown in FIG. 15, it is also possible to use two sandwiching plates 475 and 475 rendered relatively movable by using a hinge unit 475d. In this structure, it is only necessary to provide the clip member 90 serving as the engaging mechanism on the end edges on just one side of the sandwiching plates 475 and 475. It is therefore possible to decrease the number of components and to achieve reduction in assembly procedures as well as cost reduction.

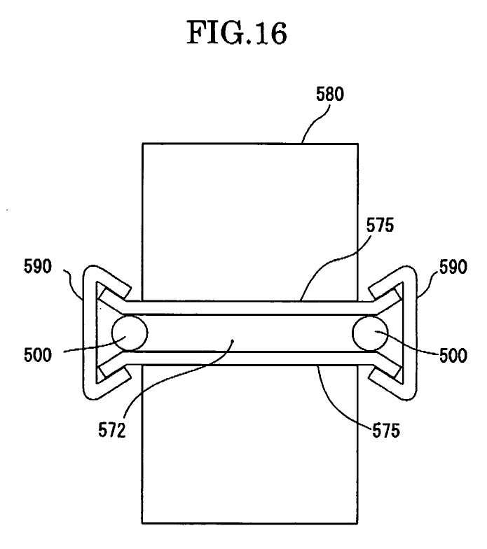

Meanwhile, the first example to the third example show the case of causing current to flow into the PTC elements 72 through the electrode plate 73 and the sandwiching plates 75 and 375. However, the present invention is not limited only to this configuration. It is possible to cause current to flow into the PTC elements 72 by providing two electrode plates 73, or alternatively, to use two sandwiching plates 575 and 575 as electrodes as shown in FIG. 16.

In this example shown in FIG. 16, an insulative member is used for a clip member 590. Meanwhile, it is also possible to provide insulating members 500 and 500 between the sandwiching plates 575 and 575 when necessary.

Meanwhile, the engaging mechanism that is provided separately from the sandwiching plates is not limited only to the clip member 90 as shown in the first example. It is possible to use another measure as long as such a measure can be engaged with the end edges of the sandwiching plates 75 so that apply a load is applied to both of the sandwiching plates.

Meanwhile, the first example shows the locking claw portions 75b that protrude toward the front surface of the respective sandwiching plates 75 as the concavo-convex shaped portions. However, the present invention is not limited only to this configuration. It is possible to bend the end edges of each sandwiching plate partially toward the rear surface so as to be engageable with the engaging piece 92.

### INDUSTRIAL APPLICABILITY

The above-described examples have shown the case of applying the present invention to the electric heating device for a vehicle. However, the present invention is not limited only to these examples. For instance, the present invention is applicable to an electric heating device for family use or for factory use. The key point is that, the present invention is applicable to an air conditioning device in every field as long as, in the air-conditioning device, a heating unit is accommodated in a casing member and the casing member is provided in contact with a fin member.

1. An electric heating device, comprising:
a heating unit having a heating element which is formed in an elongated shape and is configured to generate heat by current flow therethrough;
a casing member provided outside the heating unit; and
a fin member provided in contact with the casing member, and configured to radiate the heat generated in the heating unit into the atmosphere,
wherein the casing member includes a pair of sandwiching plates configured to hold a constituent of the heating unit having the heating element from both sides of the constituent in a sandwiching manner;
the fin member is brazed onto a front surface of each of the pair of sandwiching plates, a rear surface of each of the pair of sandwiching plates being a surface by which the constituent is held; and
an engaging mechanism is provided to engage end edges of the respective sandwiching plates with each other while applying a load onto the sandwiching plates in a direction sandwiching the constituent.

2. The electric heating device according to claim 1, wherein the engaging mechanism has a structure in which at least one of the engaging mechanism and the sandwiching plates is elastically deformed while the engaging mechanism and the sandwiching plates are in an engaged state with each other, and in which an elastic restoring force is caused to act as the load in the sandwiching direction.

3. The electric heating device according to claim 2, wherein
the engaging mechanism is a clip member fixed to the end edges of the sandwiching plates; and
the clip member includes a pair of engaging pieces each configured to be engaged with the front surface of the corresponding sandwiching plate, and is formed to be elastically deformed in a direction widening a distance between the engaging pieces and to apply the restring force in a direction reducing the distance between the engaging pieces.

4. The electric heating device according to claim 3, wherein each of the end edges of the sandwiching plates is provided with a concavo-convex shaped portion thereon configured to be engaged with the corresponding engaging piece of the clip member along a width direction of the sandwiching plate, so as to prevent the engaging piece from being separated from the corresponding sandwiching plate.

5. The electric heating device according to claim 2, wherein the engaging mechanism includes an engaging claw formed integrally in at least one of the sandwiching plates, and configured to be engaged with the end edge of the other one of the sandwiching plates.

6. The electric heating device according to claim 5, wherein a protrusion is formed on the end edge of the other one of the sandwiching plates to be engaged with the engaging claw, the protrusion being configured to shift a position of engagement with the engaging claw away from the front surface of the other sandwiching plate.

7. The electric heating device according to claim 6, wherein the engaging claw and the protrusion are alternately provided in the end edges of each of the sandwiching plates in A longitudinal direction, and the engaging claw and the protrusion are arranged alternately in a width direction so as to be engaged with each other when the pair of sandwiching plates are faced to each other.

8. The electric heating device according to claim 1, wherein notches are formed on both ends, in a width direction, of a base end portion of the fin member, onto which each of the sandwiching plates are brazed, so that interference of the engaging mechanism with the fin member is avoided.

9. The electric heating device according to claim 1, wherein
the constituent of the heating unit includes
a positioning plate including a plurality of positioning holes arranged in a longitudinal direction and each configured to position the heating element;
an electrode plate stacked on the positioning plate so as to be in contact with either top or bottom surfaces of the heating element; and
an insulating plate interposed between the electrode plate and one of the sandwiching plates so as to insulate electricity between the electrode plate and the one of the sandwiching plates, and wherein
the sandwiching plate and the electrode plate are used as positive and negative electrodes, respectively.

10. A method of manufacturing the electric heating device according to claim 1, comprising the steps of:
preliminarily brazing the fin member onto the front surface of each of the sandwiching plates to join the fin member to the front surface of each of the sandwiching plates;
sandwiching the constituent of the heating unit between the rear surfaces of the pair of sandwiching plates; and
engaging the end edges of both of the sandwiching plates with each other by use of the engaging mechanism.
